(19) United States
(12) Patent Application Publication
(10) Pub. No.: US 2010/0289987 A1
(43) Pub. Date: Nov. 18, 2010

(54) FLEXIBLE LIQUID CRYSTAL DISPLAY DEVICE

(75) Inventors: Yu-Yang Chang, Hsinchu County (TW); Kuo-Chang Lee, Pingtung County (TW); Cheng-Chung Lee, Hsinchu City (TW)

Correspondence Address: QUINTERO LAW OFFICE, PC, 615 Hampton Dr, Suite A202, Venice, CA, 90291, US

(73) Assignee: INDUSTRIAL TECHNOLOGY RESEARCH INSTITUTE, HSINCHU (TW)

(21) Appl. No.: 12/690,911

(22) Filed: Jan. 20, 2010

(30) Foreign Application Priority Data
May 14, 2009 (TW) TW098115981

(51) Int. Cl. G02F 1/1347; G02F 1/1343

(52) U.S. Cl. 349/78; 349/143

(57) ABSTRACT

A flexible LCD device is provided, including a flexible substrate having a first side and a second side, wherein the first side is perpendicular to the second side. A first electrode is disposed over the flexible substrate, extending along a first direction, wherein the first direction is not perpendicular to the first side and the second side of the flexible substrate. A first liquid crystal layer is disposed over the first electrode. A colored layer is disposed over the first liquid crystal layer. A second electrode is disposed over the colored layer, extending along a second direction, wherein the second direction is different from the first direction and is not perpendicular to the first side and the second side of the flexible substrate and the second direction is interlaced with the first direction.

### CROSS REFERENCE TO RELATED APPLICATIONS

This Application claims priority of Taiwan Patent Application No. 98115981, filed on May 14, 2009, the entirety of which is incorporated by reference herein.

### BACKGROUND OF THE INVENTION

1. Field of the Invention

The present invention relates to flexible display devices, and in particular, to flexible liquid crystal display (flexible LCD) devices.

2. Description of the Related Art

Cathode ray tube (CRT) devices have been largely replaced by liquid crystal display (LCD) devices for displaying systems.

However, due to weight and thickness of LCD devices made with glass substrates, application thereof in portable electronic devices has been hindered.

Therefore, flexible liquid crystal display (flexible LCD) devices have been developed for application in portable electronic devices. Flexible LCD devices made with flexible material such as plastic are lighter and thinner than those made with glass substrates. Some electronic devices using flexible LCD devices are electronic books (E-books), electronic papers (E-papers), and electronic billboards.

In U.S. Pat. No. 6,639,637, Stephenson discloses a passive matrix type liquid crystal display (LCD) device utilizing a flexible plastic substrate. Perpendicular patterned conductive layers for driving liquid crystals are perpendicularly disposed on corresponding sides of the flexible plastic substrate. Nevertheless, display quality diminishes when there is insufficient driving voltage applied to the patterned conductive layer. Specifically, because the passive matrix type LCD device has a high aspect ration (e.g. an aspect ratio greater than 2:1), a length of the patterned conductive layer extending along the longer side of the passive matrix type LCD device maybe too long, thus a driving voltage applied thereto may be dropped and being inefficient with progress thereof along length of the patterned conductive layer extending along the longer side of the passive matrix type LCD device. In addition, since the patterned conductive layers are perpendicularly disposed on corresponding sides of the flexible plastic substrate, the patterned conductive layers may crack or break when bent if the passive matrix type LCD device is bent.

Thus, an electrode structure for passive matrix type LCD devices which minimizes insufficient driving voltage and cracking or breaking of patterned conductive layers therein is desired.

### BRIEF SUMMARY OF THE INVENTION

Accordingly, flexible liquid crystal display (flexible LCD) devices with improved electrode structures are provided to overcome the above mentioned problems.

An exemplary flexible LCD device comprises a flexible substrate having a first side and a second side, wherein the first side is perpendicular to the second side. A first electrode is disposed over the flexible substrate, extending along a first direction, wherein the first direction is not perpendicular to the first side and the second side of the flexible substrate. A first liquid crystal layer is disposed over the first electrode. A colored layer is disposed over the first liquid crystal layer. A second electrode is disposed over the colored layer, extending along a second direction, wherein the second direction is different from the first direction and is not perpendicular to the first side and the second side of the flexible substrate, and the second direction is interlaced with the first direction.

Another exemplary flexible LCD device comprises a flexible substrate having a first side and a second side, wherein the first side is perpendicular to the second side. A first electrode is disposed over the flexible substrate, extending along a first direction, wherein the first direction is not perpendicular to the first side and the second side of the flexible substrate. A first liquid crystal layer is disposed over the first electrode and the flexible substrate. A second electrode is disposed over the first liquid crystal layer, extending along a second direction, wherein the second direction is different from the first direction and is not perpendicular to the first side and the second side of the flexible substrate, and the second direction is interlaced with the first direction. A first insulating layer is disposed over the second electrode, covering the first liquid crystal layer. A third electrode is disposed over the first insulating layer, extending along the first direction, wherein the third electrode substantially aligns with the first electrode. A second liquid crystal layer is disposed over the third electrode and the first insulating layer. A light absorbing layer is disposed over the second liquid crystal layer. A fourth electrode is disposed over the light absorbing layer, extending along the second direction, wherein the fourth electrode substantially aligns with the second electrode.

Yet another exemplary flexible LCD device comprises a flexible substrate having a first side and a second side, where the first side is perpendicular the second side. A first electrode is disposed over the flexible substrate, extending along a first direction, wherein the first direction is not perpendicular to the first side and the second side of the flexible substrate. A first liquid crystal layer is disposed over the first electrode and the flexible substrate. A second electrode is disposed over the first liquid crystal layer, extending along a second direction, wherein the second direction is not perpendicular to the first side and the second side of the flexible substrate, and the second direction is interlaced with the first direction. A first insulating layer is disposed over the second electrode, covering the first liquid crystal layer. A third electrode is disposed over the first insulating layer, extending along the first direction, wherein the third electrode aligns with the first electrode. A second liquid crystal layer is disposed over the third electrode and the first insulating layer. A fourth electrode is disposed over the second liquid crystal layer, extending along the second direction, wherein the fourth electrode substantially aligns with the second electrode. A second insulating layer is disposed over the fourth electrode, covering the second liquid crystal layer. A fifth electrode is disposed over the second insulating layer, extending along the first direction, wherein the fifth electrode substantially aligns with the third electrode and the first electrode. A third liquid crystal layer is disposed over the fifth electrode and the second insulating layer. A light absorbing layer is disposed over the third liquid crystal layer. A sixth electrode is disposed over the light absorbing layer, extending along the second direction, wherein the sixth electrode substantially aligns with the fourth electrode and the second electrode.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a plan view of a flexible liquid crystal display device according to an embodiment of the invention;

FIG. 2 is a stereo diagram of the flexible liquid crystal display device taken along line A-A in FIG. 1;

FIG. 3 is a stereogram of a flexible liquid crystal display device according to another embodiment of the invention; and

FIG. 4 is a stereogram of a flexible liquid crystal display device according to yet another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

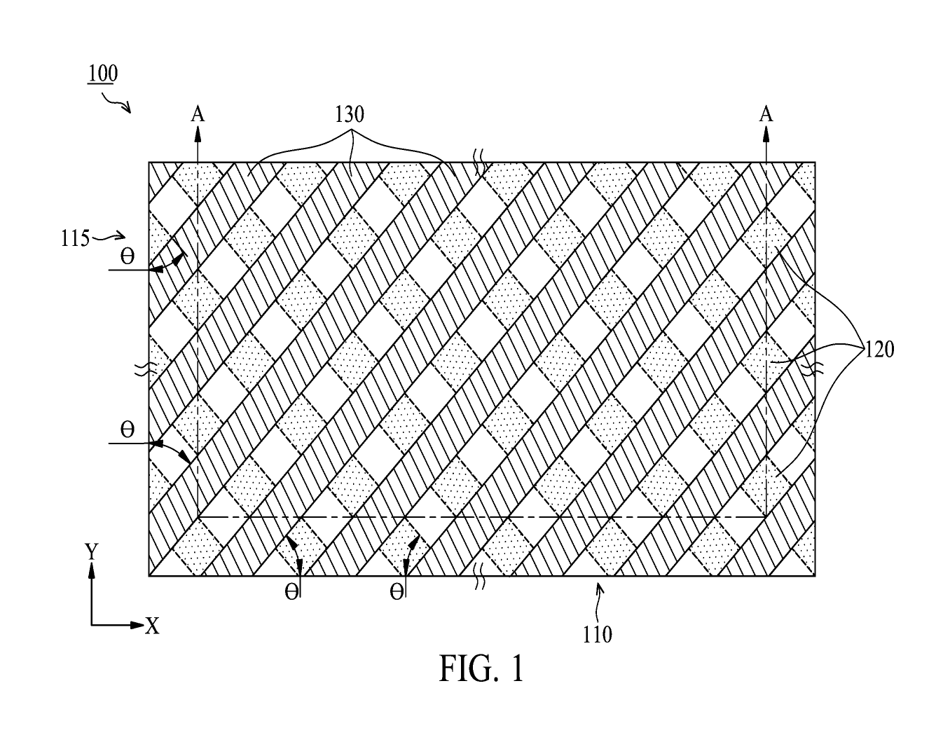

FIGS. 1-4 are schematic diagrams showing various exemplary embodiments of flexible LCD devices.

In FIG. 1, a plan view of an exemplary flexible LCD device 100 is illustrated. The flexible LCD device 100 is a passive matrix type LCD device and only a portion of a pixel region in the flexible LCD device 100 is illustrated, for simplicity.

As shown in FIG. 1, the pixel region of the flexible LCD device is formed with a substantially rectangular configuration and has a long side 110 parallel to an x direction as shown in FIG. 1 and a short side parallel to a y direction as shown in FIG. 1. The long side 110 and the short side 115 are formed with an aspect ratio greater than 2:1 therebetween, preferably greater than 10:1. Thus, application in electronic devices such as large-sized electronic billboards may be considered. In addition, the flexible LCD device 110 also includes a plurality of electrodes 120 and 130. As shown in FIG. 1, the electrodes 120 and the electrodes 130 are formed and arranged in different layers. The electrodes 130 are disposed in an upper layer (not shown, illustrated in solid lines) and the electrodes 120 are disposed in a lower layer (not shown, illustrated in dotted lines). Herein, the electrodes 130 and the electrodes 120 are not perpendicular to the long side 110 and the short side 115 of the flexible LCD device 110 and may have an included angle θ therebetween. Herein, the included angle θ is an acute angle of about 10-80 degrees, preferably of about 45 degrees. If the included angle θ is at 45 degrees, the electrodes 130 and the electrodes 120 will be perpendicular to each other. As shown in FIG. 1, if the included angle θ is not at an acute angle of 45 degree, the electrodes 130 and the electrodes 120 will not be perpendicular to each other and the included angle will not be 90 degrees (not shown).

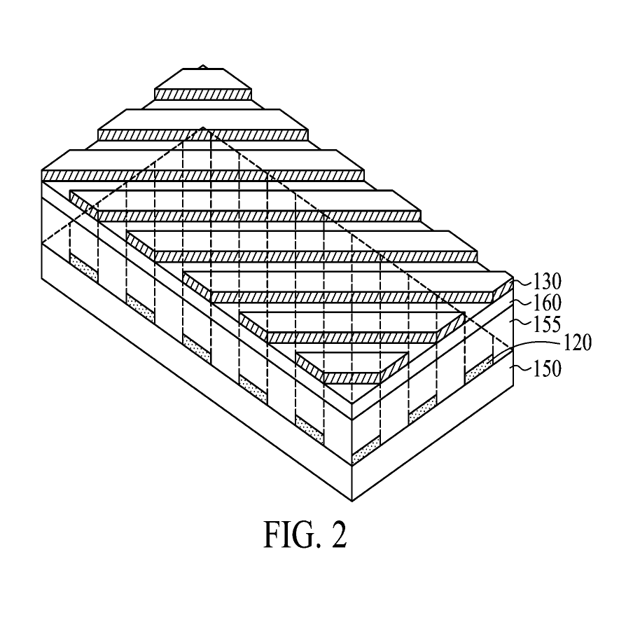

In FIG. 2, a stereo diagram of the flexible liquid crystal display device taken along line A-A in FIG. 1 is illustrated, partially illustrating a pixel region in the flexible LCD device 100.

As shown in FIG. 2, the flexible LCD device 100 includes a flexible substrate 150 and the electrodes 120 are disposed over the flexible substrate 150. The electrodes 120 are not perpendicular to the short side 115 and the long side 110 of the flexible substrate 150, and has an acute angle (i.e. the included angle θ in FIG. 1) included therebetween. The flexible substrate 150 can be made of flexible materials such as polymer plastics and is formed with a thickness of about 50-300 μm. A liquid crystal layer 155 is disposed over the electrodes 120, having a thickness of about 2-20 μm. The liquid crystal layer 155 is also disposed over the flexible substrate 150 between the electrodes 120. The liquid crystal layer 155 may comprise materials such as twisted nematic liquid crystals, cholesteric liquid crystals, ferroelectric liquid crystals or mesoporous liquid crystals. A colored layer 160 with a thickness of about 0.1- 5 μm is disposed over the liquid crystal layer 155 and may comprise materials such as pigments or dyes of a predetermined color. A plurality of electrodes 130 is disposed over the colored layer 160.

In this embodiment, one of the electrodes 120 or the electrodes 130 are transparent electrodes which comprise transparent conductive materials such as tin oxide or indium tin oxide (ITO), and the other one of the electrodes 120 and the electrodes 130 are opaque electrodes which comprise metal materials such as Al, Sn, Ag, Pt or W. The electrodes 120 and 130 are formed with a thickness of about 1-30 μm. In the embodiment illustrated in FIG. 2, the flexible liquid crystal display device 100 is a monochrome liquid crystal display device which displays images of a predetermined color depending on the color of the colored layer 160

Compared with the patterned conductive layers in prior art flexible LCD devices, the electrodes 120 and the electrodes 130 of the flexible liquid crystal display device 100 in this embodiment are formed with closer electrode lengths. Thus, pressure drop of a driving voltage applied to the electrodes may not be happened sufficient driving voltage can be provided thereto; even if the aspect ratio of the long side 110 and the short side 115 of the flexible liquid crystal display device 100 is greater than 10:1. Moreover, since the electrodes 120 and the electrodes 130 are not perpendicular to the long side 110 and short side 115 of the flexible liquid crystal display device 100, the electrodes do not crack or break when the flexible liquid crystal display device 100 is bent.

In addition to monochrome LCD device applications, the flexible LCD device 100 can also be applied to multi-colored LCD devices or full-colored LCD devices.

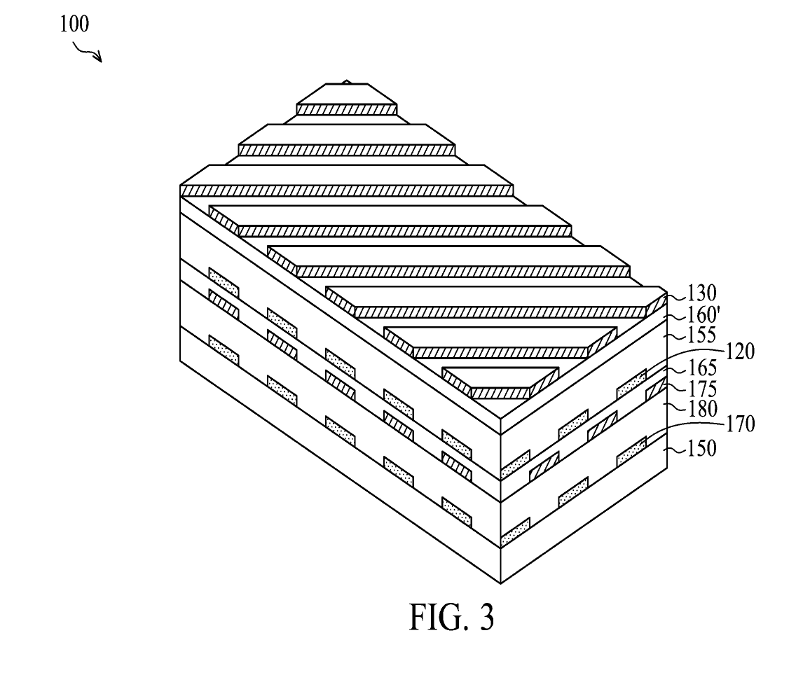

As shown in FIG. 3, a stereo diagram showing another exemplary flexible liquid crystal display device 100 is illustrated, wherein a structure similar with that illustrated in FIG. 1 is illustrated and the same titles represent the same components. The main differences between the flexible liquid crystal display devices 100 illustrated in FIGS. 2 and 3 are as follows.

As shown in FIG. 3, the electrodes 120 are disposed over an insulating layer 165 but not disposed over the flexible substrate 150 as shown in FIG. 2. A plurality of electrodes 170 and 175 are disposed between the flexible substrate 150 and the insulating layer 165, wherein the electrodes 170 are disposed over the flexible substrate 150 and a liquid crystal layer 180 is formed over the electrodes 170. The liquid crystal layer 180 also covers the flexible substrate 150 exposed by the electrodes 170. In addition, the electrodes 175 are disposed over the liquid crystal layer 180. In this embodiment, the electrodes 170 substantially align with the electrodes 120 and the electrodes 175 substantially align with the electrodes 130. Therefore, electrodes 120 substantially cover electrodes 170 and the electrodes 130 substantially cover the electrodes 175, thereby having a plan view substantially the same with that shown in FIG. 1. The insulating layer 165 covers the liquid crystal layer 180 under the electrodes 175 and has a thickness of about 1-20 μm.

In this embodiment, similar with the electrodes 120 and the electrodes 130, the long sides 110 and short sides 115 of the flexible LCD device 100 and the electrodes 170 and the electrodes 175 have an included angle of about 10-80 degrees. The liquid crystal layer 180 is the same as the liquid crystal layer 155 and may comprise materials such as twisted nematic liquid crystals, cholesteric liquid crystals, ferroelectric liquid crystals or mesoporous liquid crystals. The liquid crystal layer 155 and 180 can be formed with a different color such as red, blue, green, cyan, magenta, or yellow. In addition, a light absorbing layer 160′ rather than the colored layer 160 as shown in FIG. 2 is provided between the electrodes 130 and the liquid crystal layer 155 to thereby filter incident light (not shown) of predetermined wavelength.

As shown in FIG. 3, one of the electrodes 130 and the electrodes 170 is a transparent electrode and the other one is an opaque electrode. In addition, the electrodes 120 and the electrodes 175 are both transparent electrodes. Materials and thicknesses of the electrodes 170, 175, and the liquid crystal 180 are the same with that described in the previous embodiment and are not discussed here again, for simplicity.

In the embodiment shown in FIG. 3, the flexible LCD device 100 is a multi-color LCD device for displaying an multiple colored image rather than full color image and may have the same advantages over prior art as those described in the previous embodiment.

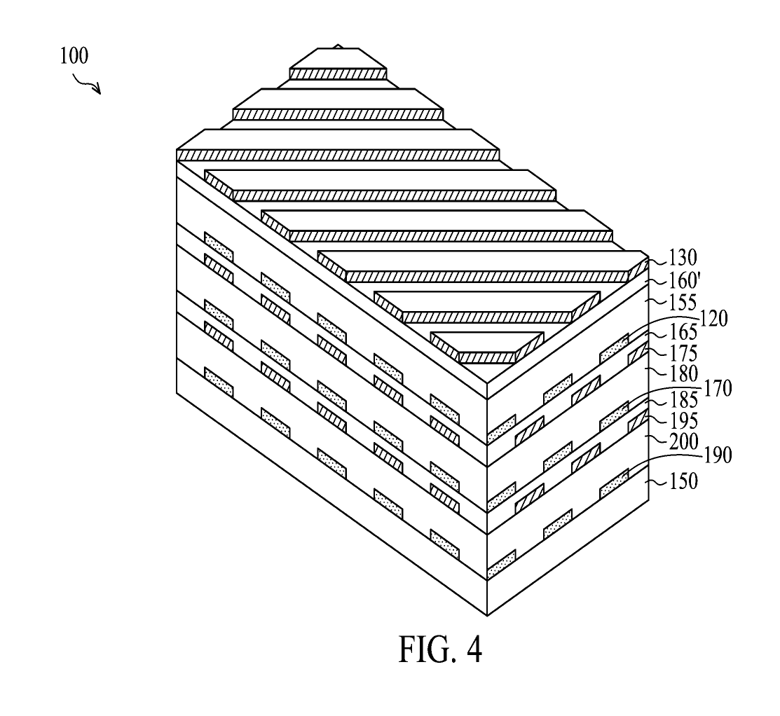

As shown in FIG. 4, a stereo diagram showing yet another exemplary flexible liquid crystal display device 100 is illustrated, wherein a structure similar with that illustrated in FIG. 3 is illustrated and the same titles represent the same components The main differences therebetween are discussed as follows .

As shown in FIG. 4, the electrodes 170 are disposed over an insulating layer 185 but not the flexible substrate 150 as shown in FIG. 3. A plurality of electrodes 190 and 195 are disposed between the flexible substrate 150 and the insulating layer 185, wherein the electrodes 190 are disposed over the flexible substrate 150 and a liquid crystal layer 200 is formed over the electrodes 170. The liquid crystal layer 200 also covers the flexible substrate 150 exposed by the electrodes 190. In addition, the electrodes 195 are disposed over the electrodes 100. In this embodiment, the electrodes 190 substantially align with the electrodes 120 and the electrodes 195 substantially align with electrodes 130. Therefore, electrodes 120 substantially cover electrodes 170 and the electrodes 130 substantially cover the electrodes 175, thereby having a plan view substantially the same with that shown in FIG. 1. The insulating layer 185 covers the liquid crystal layer 195 under the electrodes 195 and has a thickness of about 1-20 μm.

In this embodiment, similar with the electrodes 120, 130, 170, and 175, the long side 110 and short side 115 of the flexible LCD device 100 and the electrodes 190 and the electrodes 195 have an included angle of about 10-80 degrees. The liquid crystal layer 2000 is the same with the liquid crystal layer 155 and 180 and may comprise material such as twisted nematic liquid crystals, cholesteric liquid crystals, ferroelectric liquid crystals or mesoporous liquid crystals. The liquid crystal layer 155, 180, and 200 can be formed with a different color such as red, blue, green, cyan, magenta, or yellow. In addition, a light absorbing layer 160′ is provided between the electrodes 130 and the liquid crystal layer 155 rather than the colored layer 160 illustrated in FIG. 2 to thereby filter incident light (not shown) of predetermined wavelength.

As shown in FIG. 4, one of the electrodes 130 and the electrodes 190 is a transparent electrode and the other one is an opaque electrode. In addition, the electrodes 120, 175, 170, and 190 are all transparent electrodes. Materials and thicknesses of the electrodes 190, 195, and the liquid crystal 200 are the same with that previous described and are not discussed here again, for simplicity.

In the embodiment shown in FIG. 4, the flexible LCD device 100 is a full-color LCD device for displaying an image of full color and may have advantages which are the same as that described for the previous embodiments.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A flexible liquid crystal display (flexible LCD) device, comprising:
a flexible substrate having a first side and a second side, wherein the first side is perpendicular to the second side;
a first electrode disposed over the flexible substrate, extending along a first direction, wherein the first direction is not perpendicular to the first side and the second side of the flexible substrate;
a first liquid crystal layer disposed over the first electrode;
a colored layer disposed over the first liquid crystal layer; and
a second electrode disposed over the colored layer, extending along a second direction, wherein the second direction is different from the first direction and is not perpendicular to the first side and the second side of the flexible substrate, and the second direction is interlaced with the first direction.

2. The flexible LCD device as claimed in claim 1, wherein the first side and the second side of the flexible substrate have an aspect ratio therebetween of greater than 2:1.

3. The flexible LCD device as claimed in claim 1, wherein the first side of the flexible substrate is a long side, and the first electrode and the first side of the flexible substrate have an included angle of about 10-80 degrees therebetween.

4. The flexible LCD device as claimed in claim 3, wherein the first electrode and the first side of the flexible substrate have an included angle of about 45 degrees therebetween.

5. The flexible LCD device as claimed in claim 4, wherein the first direction of the first electrode is perpendicular to the second direction of the second electrode.

6. The flexible LCD device as claimed in claim 1, wherein the first liquid crystal layer comprises twisted nematic liquid crystals, cholesteric liquid crystals, ferroelectric liquid crystals or mesoporous liquid crystals.

7. The flexible LCD device as claimed in claim 1, wherein one of the first and second electrodes is a transparent electrode.

8. The flexible LCD device as claimed in claim 1, wherein the first and second electrodes are formed with a strip shape, rectangular shape, zigzag strip shape, curved line shape, polygonal shape, oval shape, or circular shape when viewed from a plan view.

9. The flexible LCD device as claimed in claim 1, wherein the flexible LCD device is a monochrome LCD device.

10. A flexible liquid crystal display (flexible LCD) device, comprising:
a flexible substrate having a first side and a second side, wherein the first side is perpendicular to the second side;
a first electrode disposed over the flexible substrate, extending along a first direction, wherein the first direction is not perpendicular to the first side and the second side of the flexible substrate;
a first liquid crystal layer disposed over the first electrode and the flexible substrate;
a second electrode disposed over the first liquid crystal layer, extending along a second direction, wherein the second direction is different from the first direction and is not perpendicular to the first side and the second side of the flexible substrate, and the second direction is interlaced with the first direction;
a first insulating layer disposed over the second electrode, covering the first liquid crystal layer;
a third electrode disposed over the first insulating layer, extending along the first direction, wherein the third electrode substantially aligns with the first electrode;
a second liquid crystal layer disposed over the third electrode and the first insulating layer;
a light absorbing layer, disposed over the second liquid crystal layer; and
a fourth electrode disposed over the light absorbing layer, extending along the second direction, wherein the fourth electrode substantially aligns with the second electrode.

11. The flexible LCD device as claimed in claim 10, wherein the first side of the flexible substrate is a long side, and the first side of the flexible substrate and the first electrode and the third electrode have an included angle of about 10-80 degrees therebetween.

12. The flexible LCD device as claimed in claim 11, wherein the first side of the flexible substrate and the first electrode and the third electrode have an included angle of about 45 degrees therebetween.

13. The flexible LCD device as claimed in claim 12, wherein the first direction of the first electrode and the third electrode is perpendicular to the second direction of the fourth electrode.

14. The flexible LCD device as claimed in claim 11, wherein the first and second liquid crystal layers comprise twisted nematic liquid crystals, cholesteric liquid crystals, ferroelectric liquid crystals or mesoporous liquid crystals.

15. The flexible LCD device as claimed in claim 11, wherein one of the first and fourth electrodes is a transparent electrode, and the second and third electrodes are both transparent electrodes.

16. The flexible LCD device as claimed in claim 11, wherein the first, second, third and fourth electrodes are formed with a strip shape, rectangular shape, zigzag strip shape, curved line shape, polygonal shape, oval shape, or circular shape when viewed from a plan view.

17. The flexible LCD device as claimed in claim 11, wherein the first and second liquid crystal layers are formed of different colors, and the flexible LCD device is a multi-colored LCD device.

18. A flexible liquid crystal display (flexible LCD) device, comprising:
a flexible substrate having a first side and a second side, wherein the first side is perpendicular to the second side;
a first electrode disposed over the flexible substrate, extending along a first direction, wherein the first direction is not perpendicular to the first side and the second side of the flexible substrate;
a first liquid crystal layer disposed over the first electrode and the flexible substrate;
a second electrode disposed over the first liquid crystal layer, extending along a second direction, wherein the second direction is not perpendicular to the first side and the second side of the flexible substrate, and the second direction is interlaced with the first direction;
a first insulating layer disposed over the second electrode, covering the first liquid crystal layer;
a third electrode disposed over the first insulating layer, extending along the first direction, wherein the third electrode aligns with the first electrode;
a second liquid crystal layer disposed over the third electrode and the first insulating layer;
a fourth electrode disposed over the second liquid crystal layer, extending along the second direction, wherein the fourth electrode substantially aligns with the second electrode;
a second insulating layer disposed over the fourth electrode, covering the second liquid crystal layer;
a fifth electrode disposed over the second insulating layer, extending along the first direction, wherein the fifth electrode substantially aligns with the third electrode and the first electrode;
a third liquid crystal layer disposed over the fifth electrode and the second insulating layer;
a light absorbing layer, disposed over the third liquid crystal layer; and
a sixth electrode disposed over the light absorbing layer, extending along the second direction, wherein the sixth electrode substantially aligns with the fourth electrode and the second electrode.

19. The flexible LCD device as claimed in claim 18, wherein the first side and the second side of the flexible substrate have an aspect ratio not more than 10:1 therebetween.

20. The flexible LCD device as claimed in claim 18, wherein the first side of the flexible substrate is a long side, and the first side of the flexible substrate and the first electrode, the third electrode, and the fifth electrode have an included angle of about 10-80 degrees therebetween.

21. The flexible LCD device as claimed in claim 20, wherein the first side of the flexible substrate and the first electrode, the third electrode, and the fifth electrode have an included angle of about 45 degrees therebetween.

22. The flexible LCD device as claimed in claim 21, wherein the first direction of the first electrode, the third electrode and the fifth electrode is perpendicular to the second direction of the second electrode.

23. The flexible LCD device as claimed in claim 18, wherein the first, second and third liquid crystal layers comprise twisted nematic liquid crystals, cholesteric liquid crystals, ferroelectric liquid crystals or mesoporous liquid crystals.

24. The flexible LCD device as claimed in claim 18, wherein one of the first and sixth electrodes is a transparent electrode, and the second, third, fourth, and fifth electrodes are all transparent electrodes.

25. The flexible LCD device as claimed in claim 18, wherein the first, second, third, fourth, fifth and sixth electrodes are formed with a strip shape, rectangular shape, zigzag strip shape, curved line shape, polygonal shape, oval shape, or circular shape when viewed from a plan view.

26. The flexible LCD device as claimed in claim 18, wherein the first, second, and liquid crystal layers are formed of different colors, and the flexible LCD device is a full-color LCD device.
